(19) United States
(12) Patent Application Publication
(10) Pub. No.: US 2007/0124367 A1
(43) Pub. Date: May 31, 2007

(54) Integrated Mobile Diagnostics and Electronic Customer Care Test Script with Browser

(76) Inventors: Guoxin Fan, Plano, TX (US); Vani Budhati, Garland, TX (US); Sudheer Kumar Peddireddy, Garland, TX (US)

Correspondence Address: CONLEY ROSE, P.C., 5700 GRANITE PARKWAY, SUITE 330, PLANO, TX, 75024, US

(21) Appl. No.: 11/468,140

(22) Filed: Aug. 29, 2006

Related U.S. Application Data
(60) Provisional application No. 60/740,381, filed on Nov. 29, 2005.

(51) Int. Cl. G06F 15/16

(52) U.S. Cl. 709/203

(57) ABSTRACT

A system for mobile diagnostics and electronic customer care is provided. The system includes a mobile handset and a server. The mobile handset has a diagnostic software application stored on the mobile handset, and a second software application executable on the mobile handset. The server is operable to interpret results received from the diagnostic software application. The server is further operable to return updated operating parameters to the mobile handset based at least in part on the results of the diagnostic software application. The diagnostic software application is invoked using the second software application in response to the server sending a signal to the second software application.

### CROSS-REFERENCE TO RELATED APPLICATIONS

This application claims priority to U.S. patent application No. 60/740,381 entitled “Integrated Mobile Diagnostics and Electronic Customer Care Test Script with Browser”, inventors Guoxin Fan, et al. filed on Nov. 29, 2005, which is incorporated herein by reference for all purposes.

### STATEMENT REGARDING FEDERALLY-SPONSORED RESEARCH OR DEVELOPMENT

Not applicable.

### REFERENCE TO A MICROFICHE APPENDIX

Not applicable.

### BACKGROUND

Wireless communication devices are a convenient way to transmit and receive information from virtually any location. Wireless devices are now capable of sending and receiving voice communication, messages, and even provide access to the Internet. IP-Based Over-The-Air Mobile Diagnostics (“IOTA MD”) tools or applications are used for diagnosing problems with wireless communication devices and/or wireless networks. Extended Customer Care (ECC) tools or applications promote various interactions with wireless devices including conducting an RF coverage survey and/or conducting a survey of preferred web sites visited by users of the wireless devices. However, a uniform command structure has yet to be agreed upon among original equipment manufacturers (OEMs) and operating companies, and with the number of devices and the capabilities of these devices increasing, the difficulty in diagnosing and maintaining and providing survey functions using wireless communication devices has become a complex and costly enterprise.

### SUMMARY

In one embodiment, a system for mobile diagnostics and electronic customer care is provided. The system includes a mobile handset and a server. The mobile handset has a diagnostic software application stored on the mobile handset, and a second software application executable on the mobile handset. The server is operable to interpret results received from the diagnostic software application. The server is further operable to return updated operating parameters to the mobile handset based at least in part on the results of the diagnostic software application. The diagnostic software application is invoked using the second software application in response to the server sending a signal to the second software application.

In another embodiment a method is provided for diagnosing wireless devices. The method includes using a web browser on a wireless device to read a web page including an executable script. The method includes the web browser launching the executable script, and the executable script launching a diagnostics application for the wireless device. The method includes the diagnostics application providing one or more diagnostic metrics regarding the wireless device to a server.

In another embodiment, a system for mobile diagnostics is provided. The system includes a wireless handset having a web browser that is operable to execute scripts. The wireless handset also has a diagnostic application for diagnosing at least portions of the wireless handset. The system also includes a server that is operable to promote providing a web page having an executable script. The executable script is used to launch the diagnostic application on the wireless handset, such that when the web browser on the wireless handset executes the executable script, the executable script promotes launching the diagnostic application to diagnose at least portions of the wireless handset. The diagnostic application is further operable to communicate at least some diagnostic results.

These and other features and advantages will be more clearly understood from the following detailed description taken in conjunction with the accompanying drawings and claims.

### BRIEF DESCRIPTION OF THE DRAWINGS

For a more complete understanding of the presentation and the advantages thereof reference is now made to the following brief description, taken in connection with the accompanying drawings in detailed description, wherein like reference numerals represent like parts.

FIG. 1 illustrates an overview for the communication structure between wireless devices and technicians.

FIG. 2 illustrates an overview of one embodiment of the present disclosure.

FIG. 3 illustrates another embodiment of the present disclosure.

FIG. 4 illustrates one embodiment of a diagnostic routine that may be executed by an end user.

FIG. 5 illustrates a block diagram of a mobile device operable for some of the various embodiments of the present disclosure.

FIG. 6 illustrates a block diagram of a computer system operable for some of the various embodiments of the present disclosure.

### DETAILED DESCRIPTION

It should be understood at the outset that although an exemplary implementation of one embodiment of the present invention is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

Previously, Mobile Diagnostics (MD) and Extended Customer Care (ECC) routines were customized for specific models and revisions of wireless devices. This often required the operating company or telecommunications carrier to maintain multiple server applications, each server application customized for the specific model and revision of wireless device. For example, the telecommunications company may maintain a first MD/ECC-Server application to interact with a first model of a first original equipment manufacture (OEM), a second MD/ECC-Server application to interact with a second model of wireless device manufactured by the first OEM, and a third MD/ECC-Server application to interact with a third model of wireless device manufactured by a second OEM. Embodiments of the present disclosure support invocation of MD and ECC functions and capabilities with the execution of a lightweight script which communicates with an embedded hardware routine. In an embodiment, a server may invoke a single JavaScript script function on any of a number of different wireless handsets, and each different wireless handset may map the single JavaScript function invocation to a native function unique to that specific handset. This framework or system provides for a unified server executing common MD and/or ECC applications, for example, in a telecommunication company's enterprise, while leaving the OEMs free to implement proprietary embedded hardware routines responsive to the MD and ECC applications.

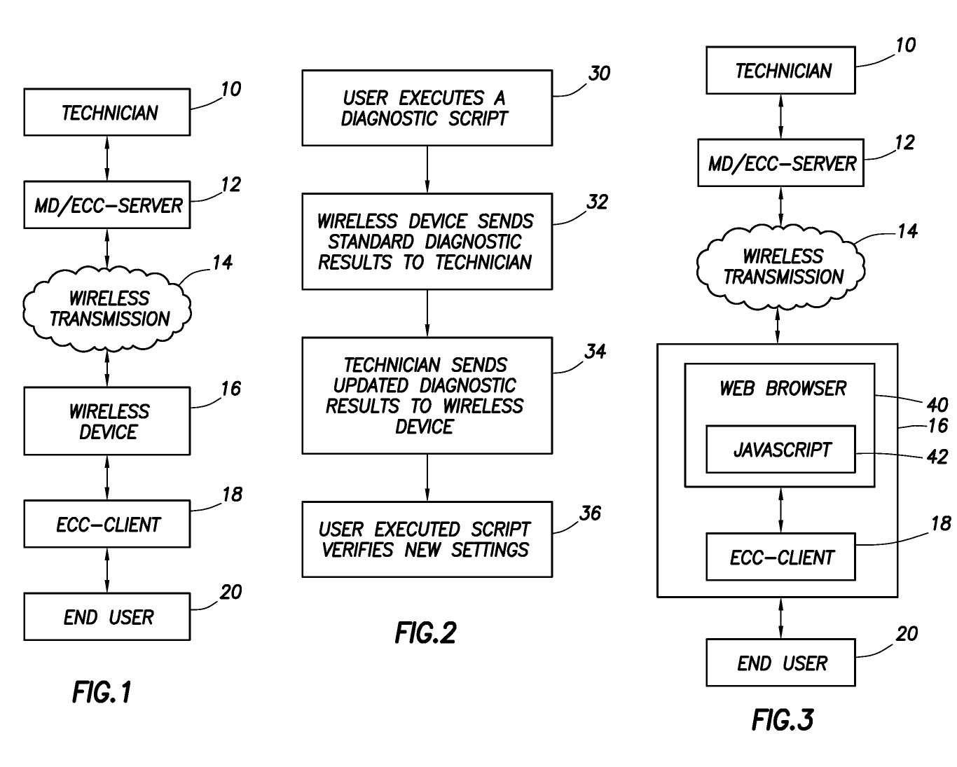

FIG. 1 shows one configuration of the connection of wireless devices to a MD/ECC-Server. A technician 10, such as a customer service representative of a telecommunications company, operates an MD/ECC-Server 12. A wireless transmission 14 is maintained between MD/ECC-Server 12 and a wireless device 16. Wireless transmission 14 may take place using a network including, but not limited to, a GPRS network, a CDMA network, an EDGE network, the internet or other networks. Examples of wireless devices include, but are not limited to, wireless mobile phones, computers with wireless adapters, personal data assistants (PDAs) with wireless adapters, wireless enabled laptop computers, and wireless access points.

Each wireless device has a type of diagnostic software, sometimes referred to as an ECC-Client 18. An end user 20 is capable of manipulating the wireless device to perform certain functions, such as placing the wireless device into a diagnostic mode.

Previously it was challenging to diagnose wireless communication devices. For example, if a subscriber identified a wireless service problem to their wireless service provider, the wireless service providers technicians typically had to first identify which type of wireless device model the subscriber was using. Then the provider might use a diagnostic tool to look-up the specific wireless device parameters of the wireless device model, all of which was time consuming and inefficient. The subscribers assistance might be required to place the wireless device into a diagnostic mode and enter special diagnostic codes into the wireless device.

This previous diagnostic process was tedious, error prone, and might lead to rendering the wireless device inoperable during the diagnostic procedure. Technicians were required to send specific wireless diagnostic parameters during this procedure to the wireless device and then attempt to retrieve the results. The results might be various codes that required further searching to derive their meaning. The technician often had to look-up procedures to update wireless device parameters and then send the updated operational parameters to the wireless device. Finally, the technician might have to manually test the settings. Additionally, because operating companies and/or wireless service providers typically support mobile devices manufactured by multiple different OEMs, the diagnostic tools employed by the technician were often different applications each having different operational controls and/or steps for using the diagnostic tool.

The present disclosure provides improved systems and methods for managing such diagnostics, surveys, and updates. One of the embodiments disclosed uses a platform independent MD/ECC-Server to communicate with a wireless device through the use of a ECC-Client.

FIG. 2 provides a logic flow diagram of a method of using one or more embodiments of the present disclosure. In block 30, a diagnostic script is initiated and executes. This might be controlled by either a technician using a diagnostic tool such as MD/ECC-Server 12 or by a subscriber using a user interface control on a mobile device. In block 32, the wireless device then returns standard diagnostic results, for example to a technician. In block 34, the diagnostic tool sends updated diagnostic results, for example configuration and/or setting updates, to the wireless device. At block 36, the executed script verifies new settings.

In one embodiment, a JavaScript virtual machine is used to provide a lightweight interface for mobile diagnostics for MD/ECC-Server 12. HTML browsers, which are commonly available on mobile devices, are typically capable of passing JavaScript commands to a JavaScript virtual machine for execution. This provides dynamic behavior to HTML web pages when a user clicks on or otherwise activates an active function in the web page. In this embodiment, one or more MD-ECC interfaces or exposing scripts can be embedded into an HTML document that is opened by a web browser on the wireless device. Since the JavaScript local rendering is handled by the web browser installed in the mobile device, there is no need for a graphical user interface for the test application.

This embodiment also has the advantage that the server side can define a test script in the form of a web page with some embedding JavaScript so that the test cases can be created as needed, which enables remote management to tailor diagnostic routines to specific situations. At least one application programming interface (“API”) may be used to launch the diagnostic routine; however the executed commands sent by the MD/ECC-Server, sometimes referred to as the MD/ECC engine, remain a native application. The execution of the MD/ECC engine is implemented, in some embodiments, as an ECC Client. The ECC-Client, in one embodiment, executes JavaScript commands that can be implemented as switch tables that invoke the underlining MD/ECC-Server test functions. In this embodiment, a standardized JavaScript diagnostic request can be used to make the proper MD-ECC code request, without the need for user or MD/ECC-Server input. In this way, the end user gets the best of both worlds, as the user gets the flexibility of a customizable JavaScript test routine combined with the robust native MD-ECC engine. Most common MD-ECC engines may be launched using a standard or predefined format and the relevant diagnostic information is returned in a known format, as discussed below. In this manner, diagnostics for most handsets may be readily obtained by transmitting a web page with an embedded JavaScript that launches the MD-ECC engine.

FIG. 3 illustrates one embodiment, wherein the MD-ECC engine runs native code that can be implemented as a switch table to invoke underlying test functions based on test type. In this embodiment technician 10 operates MD/ECC-Server 12. Wireless transmission 14 is maintained between MD/ECC-Server 12 and wireless device 16. In this embodiment, wireless device 16 has an embedded web browser 40, which has an implementation of JavaScript 42, and/or is operable to execute JavaScript 42. Wireless device 16 also has an ECC-Client 18 that is built into wireless device 16 for diagnostics purposes. End user 20 is capable of launching JavaScript 42 by navigating web browser 40 to the Internet location indicated by technician 10, such as an HTML (Hypertext Markup Language) web page, which in some embodiments may include JavaScript 42. In other embodiment, all or portions of JavaScript 42 may already be resident on wireless device 16. In still other embodiments, MD/ECC-Server 12 may already have JavaScript 42 or may build JavaScript 42 on demand. JavaScript 42 then launches through the wireless device 16 on the web browser 40 and communicates with the ECC-Client 18. Other methods of launching JavaScript 42 may be used, and one such embodiment is provided below.

JavaScript 42 includes the command to start ECC-Client 18, which may be or may include the MD-ECC engine, or the mobile diagnostic engine, on wireless device 16. JavaScript 42 may include logic and/or a plurality of scripts for each of the different ECC-Clients 18. The JavaScript 42 may be able to detect the type of wireless device 16, and then launch the ECC-Client 18 for the detected wireless device 16. For example, in one embodiment, MD/ECC-Server 12 may include one or more Handset Configuration Managers, or components thereof, that are operable to promote communication with ECC-Client 18.

Alternatively, MD/ECC-Server 12 might provide the technician 10 with a list or selection of wireless devices 16. Technician 10 might then select the appropriate wireless device 16 and the MD/ECC-Server 12 transmits the appropriate web page with JavaScript 42 operable to launch ECC-Client 18 that is known to be on the corresponding wireless device 16. Other techniques to launch ECC-Client 18 and/or to provide the appropriate JavaScript 42 to launch ECC-Client 18 are known and may be used and will readily suggest themselves to one skilled in the art in light of the present disclosure, all of which are within the spirit and scope of the disclosed embodiments.

Most wireless devices have different, proprietary, mobile diagnostic engines, or ECC-Clients 18. Previously, a proprietary ECC-Server might be needed to communicate with each of the different possible wireless devices, and the technician might need to be familiar with each. Using the present system, the telecommunication operator may employ MD/ECC-Server 12 and launch ECC-Client 18 resident on potentially any wireless device.

Many of the ECC-Clients 18 are standardized and communicate using a common Application Programming Interface (API) or have or accept similar or know arguments for making diagnostic requests. JavaScript 42 or other scripts can be used to request diagnostic information from wireless device 16, via ECC-Client 18. Some of these scripts or calls may be common to one or more ECC-Clients 18, or some may be unique to a specific wireless device and its proprietary ECC-Client 18. In one embodiment, MD/ECC-Server 12 manages the JavaScript 42 that launches ECC-Client 18, as well as other JavaScript 42 to allow the technician or end user 20 to make additional or supplemental requests for diagnostic information.

Web browser 68 then reports the results to the MD/ECC-Server 12 and the technician 10. Some of the ECC-Clients 18 communicate results according to a standard format or using a common API. MD/ECC-Server 12 might also be provided with or include a Metrics Collection Server, which is a well know system or receiving diagnostic metrics. ECC-Client 18 may communicate, such as via HTTP directly with MD/ECC-Server 12 to provide the diagnostics information.

Using the diagnostic information, a technician 10 may then identify problems, such as detecting hardware faults within wireless device 16. Technician 10 may send modifications to the configuration of the wireless device 16 to correct these problems. The modification are sent to browser 40 and executed as JavaScript 42 that launch ECC-Client 18 which implements any changes to wireless device 16.

In this embodiment, the testing script that allows for communication between wireless device 16 and MD/ECC-Server 12 is performed using JavaScript 42. One of the advantages to using JavaScript is that several functions within JavaScript can be used to invoke communications with ECC-Client 18 of wireless device 16. However, it is envisioned that this task could be preformed with Jscript, XML, ActiveX, or other scripting language. The choice of scripting language is limited only by the manufacturer's implementation of the software used within the wireless device.

In other embodiments, an end user 20 might initiate, diagnose, and update wireless device 16 without the support of technician 10. For example, a local client can be loaded within wireless 16 device to facilitate communication with the support server, which may be housed within or in communication with MD/ECC-Server 12. For instance, a lightweight Symbian client could be used with Symbian OS devices and a Microsoft client could be used with Windows Devices to allow for communication with support servers. Using such clients in this manner provides the ability to send standard diagnostic routines from the device to an MD/ECC-Server 12, and the ability to receive standard modifications to the configuration of the wireless devices from an MD/ECC-Server 12.

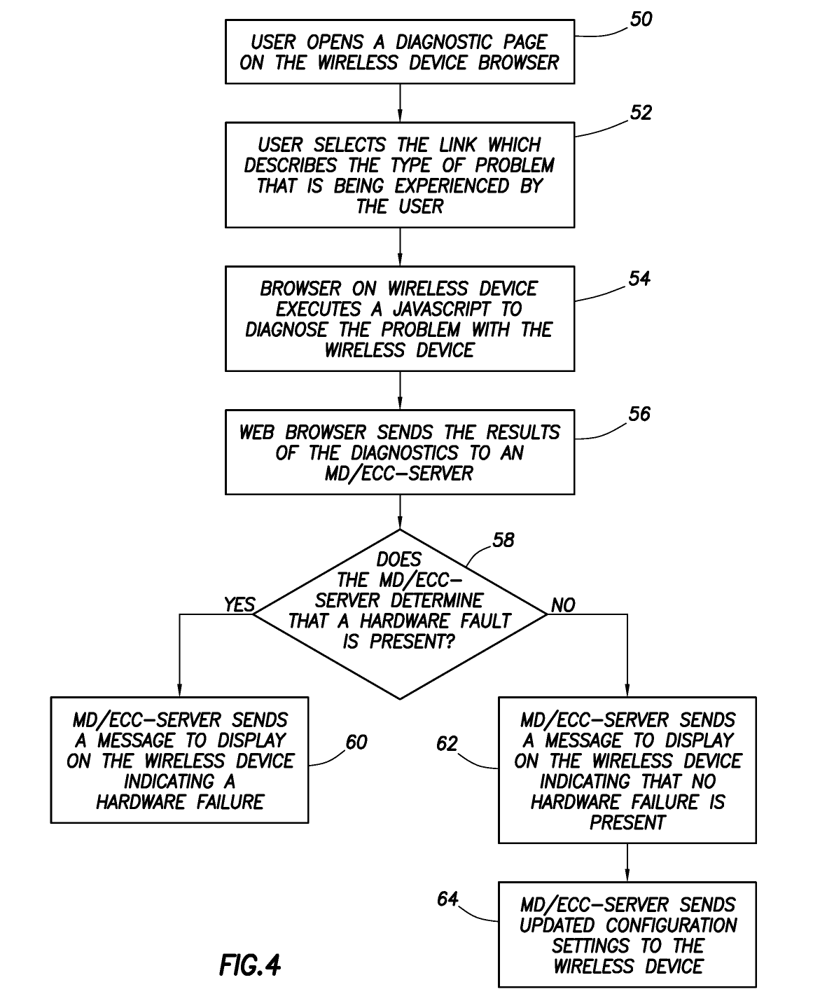

One example of the operation of this aspect of the present invention is given by FIG. 4. In block 50, the user opens a diagnostic page using the wireless device 16 browser. For example, a link to a diagnostic script may be provided on the browser installed prior to the user receiving the wireless device 16. In block 52, the user selects the link which describes the type of problem that is being experienced by the user. The page may contain a link to diagnose either severe or more general problems. In block 54, the browser executes a JavaScript to diagnose the problem with the wireless device 16. In block 56, the web browser sends the results of the diagnostics to an MD/ECC-Server 12. In block 58, the MD/ECC-Server 12, after receiving data from the wireless device 16, determines whether a hardware fault is present within the wireless device 16. If the MD/ECC-Server 12 detects a hardware fault in block 58, the MD/ECC-Server 12 sends a message to display on the wireless device 16 indicating a hardware failure, in block 60. If the MD/ECC-Server 12 does not detect a hardware fault in block 58, the MD/ECC-Server 12 sends a message to display on the wireless device 16 indicating no hardware failure is present. If there is no hardware fault and the settings adjustments are known, the MD/ECC-Server 12 sends updated configuration settings to the wireless device 16, in block 64.

This example is intended to be illustrative of one embodiment, it should be noted, however, that not all steps need to be followed or might be followed in a different order. For instance, the MD/ECC-Server 12 may skip block 62 and send the updated configuration settings to the wireless device 16 without displaying a message that no hardware failure is present. As another example, the MD/ECC-Server 12 may initiate the disclosed diagnostic routines, rather than have the user initiate them as in block 50.

It should be appreciated that while certain aspects of the present disclosure are discussed as implemented using Java and/or JavaScript, the present disclosure is not so limited and other programming languages, tools, or scripting languages, such as, but not limited to, SyncML (Synchronization Markup Language) might be used as well as will readily suggest themselves to one skilled in the art.

An exemplary mobile handset system 70 for implementing one or more embodiments disclosed herein is illustrated in FIG. 5. All or portions of the system described above may be implemented on any hand-held mobile electronic device 70 such as is well known to those skilled in the art. The mobile handset 70 includes a processor 72 (which may be referred to as a central processor unit or CPU) that is coupled to a first storage area 74, a second storage area 76, an input device 78 such as a keypad, and an output device such as a display screen 80. The mobile handset 70 may further comprise one or more antennas and a radio frequency transceiver (not shown) as is well known to those skilled in the art.

The processor 72 may be implemented as one or more CPU chips and may execute instructions, codes, computer programs, or scripts that ft accesses from the first storage area 74 or the second storage area 76. The first storage area 74 might be a non-volatile memory such as flash memory. Mobile handset 70 data would typically be installed in the first storage area 74. They second storage area 76 might be firmware or a similar type of memory. The device's operating system would typically be installed in the second storage area 76.

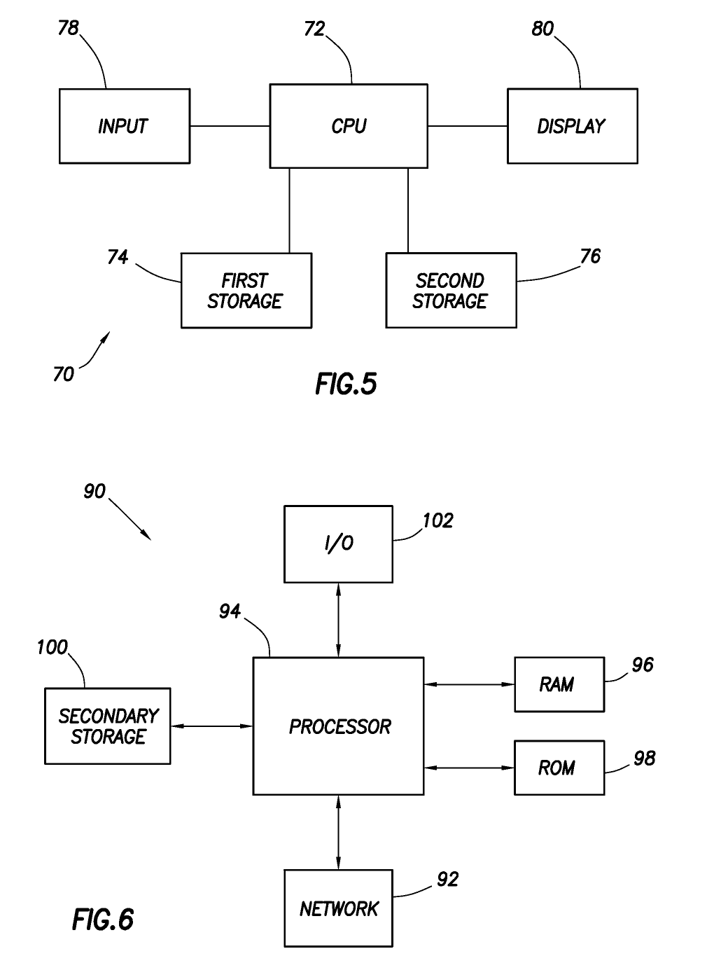

Various systems above may also be implemented on any general-purpose computer with sufficient processing power, memory resources, and network throughput capability to handle the necessary workload placed upon it. FIG. 6 illustrates a typical, general-purpose computer system suitable for implementing one or more embodiments disclosed herein. The computer system 90 includes a processor 94 (which may be referred to as a central processor unit or CPU) that is in communication with memory devices including secondary storage 100, read only memory (ROM) 98, random access memory (RAM) 96, input/output (I/O) devices 102, and network connectivity devices 92. The processor 94 may be implemented as one or more CPU chips.

The secondary storage 100 is typically comprised of one or more disk drives or tape drives and is used for non-volatile storage of data and as an over-flow data storage device if RAM 96 is not large enough to hold all working data. Secondary storage 100 may be used to store programs that are loaded into RAM 96 when such programs are selected for execution. The ROM 98 is used to store instructions and perhaps data that are read during program execution. ROM 98 is a non-volatile memory device that typically has a small memory capacity relative to the larger memory capacity of secondary storage. The RAM 96 is used to store volatile data and perhaps to store instructions. Access to both ROM 98 and RAM 96 is typically faster than to secondary storage 100.

I/O devices 102 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 92 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity devices 92 may enable the processor 94 to communicate with the Internet or one or more intranets. With such a network connection, it is contemplated that the processor 94 might receive information from a network or might output information to a network in the course of performing the above-described method steps.

Such information, which may include data or instructions to be executed using processor 94 for example, may be received from and outputted to the network, for example, in the form of a computer data baseband signal or signal embodied in a carrier wave. The baseband signal or signal embodied in the carrier wave generated by the network connectivity devices 92 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 94 executes instructions, codes, computer programs, or scripts that it accesses from hard disk, floppy disk, optical disk (these various disk-based systems may all be considered secondary storage 100), ROM 98, RAM 96, or the network connectivity devices 92.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A system for mobile diagnostics and electronic customer care, comprising:
a mobile handset having a diagnostic software application stored on the mobile handset, and a second software application executable on the mobile handset; and
a server operable to interpret results received from the diagnostic software application, the server further operable to return updated operating parameters to the mobile handset based at least in part on the results of the diagnostic software application, and wherein the diagnostic software application is invoked using the second software application in response to the server sending a signal to the second software application.

2. The system of claim 1, wherein the mobile handset is a wireless communication device selected from a group consisting of wireless mobile telephones, personal digital assistants (PDAs), wireless enabled laptop computers, and wireless access points.

3. The system of claim 1, wherein the diagnostic software application is customized to operate on the mobile handset.

4. The system of claim 1, wherein the mobile handset includes a web browser and wherein the mobile handset is operable for executing the second software application via the web browser.

5. The system of claim 1, wherein the second software application is implemented using a scripting language.

6. The system of claim 1, wherein the mobile handset communicates with the server via a network selected from a group consisting of a GPRS network a CDMA network, a GSM network, an orthogonal frequency division multiple access network, and an EDGE network.

7. The system of claim 5, wherein the scripting language is one of JavaScript and SyncML (Synchronization Markup Language).

8. The system of claim 1, wherein the second software application communicates between the diagnostic software application and the server through the use of a switch table.

9. A method for diagnosing wireless devices, comprising:
using a web browser on a wireless device to read a web page including an executable script;
the web browser launching the executable script;
the executable script launching a diagnostics application for the wireless device; and
the diagnostics application providing one or more diagnostic metrics regarding the wireless device to a server.

10. The method of claim 9, wherein the server is a customer care server, further comprising:
the customer care server analyzing the results of the diagnostic routine; and
transmitting updates to the wireless device based at least in part on the results of the analysis by the customer care server.

11. The method of claim 9, further comprising adjusting parameters of the wireless device based upon one or more diagnostic metrics.

12. The method of claim 10, wherein the server is implemented as an Electronic Customer Care (ECC) standard server.

13. The method of claim 9, wherein the executable script is selected from the group consisting of Jscript, JavaScript, SyncML (Synchronization Markup Language), and XML.

14. The method of claim 9, further comprising determining whether a defect is present with a hardware of the wireless device.

15. The method of claim 9, wherein the diagnostics application is a Mobile Diagnostics Electronic Customer Care (MD-ECC) compliant software.

16. A system for mobile diagnostics, comprising:
a wireless handset having a web browser operable to execute scripts, the wireless handset further having a diagnostic application for diagnosing at least portions of the wireless handset; and
a server operable to promote providing a web page having an executable script to launch the diagnostic application on the wireless handset, such that when the web browser on the wireless handset executes the executable script the executable script promotes launching the diagnostic application to diagnose at least portions of the wireless handset, the diagnostic application further operable to communicate at least some diagnostic results.

17. The system of claim 16, wherein the diagnostic application is a Mobile Diagnostics Electronic Customer Care (MD-ECC) compliant software, and wherein the server is implemented as an Electronic Customer Care (ECC) standard server.

18. The system of claim 17, wherein the executable script is selected from the group consisting of Jscript, JavaScript, SyncML (Synchronization Markup Language), and XML.

19. The system of claim 16, wherein wireless handset is a wireless communication device selected from a group consisting of wireless mobile telephones and personal digital assistants (PDAs).

20. The system of claim 16, wherein the server is further operable to promote communication of update parameter to the wireless handset, the diagnostic application operable to update the wireless device with the update parameters.
